(19) United States
(12) Patent Application Publication
(10) Pub. No.: US 2024/0343180 A1
(43) Pub. Date: Oct. 17, 2024

(54) LOCKABLE RATCHET STRAP

(71) Applicant: SNS SOLUTIONS LTD., Calgary (CA)

(72) Inventor: Shawn Norman SORENSEN, Calgary (CA)

(21) Appl. No.: 18/634,150

(22) Filed: Apr. 12, 2024

Related U.S. Application Data
(60) Provisional application No. 63/495,934, filed on Apr. 13, 2023.

(51) Int. Cl. B60P 7/08; E05B 73/00

(52) U.S. Cl. CPC B60P 7/083; E05B 73/0005

(57) ABSTRACT

Disclosed herein is a ratchet strap comprising a locking mechanism. The first and second arms of the ratchet strap are configurable for disposition in a locking-ready relationship. While the first and second arms are disposed in the locking-ready relationship, the locking mechanism is configurable for disposition in a locking effective configuration and a locking ineffective configuration. While the first and second arms are disposed in the locking-ready relationship, and the locking mechanism is disposed in the locking effective configuration, rotation of the first arm, relative to the second arm, in a first direction or second opposite direction, is opposed. While the first and second arms are disposed in the locking-ready relationship, and the locking mechanism is disposed in the locking ineffective configuration, there is an absence of opposition of rotation of the first arm, relative to the second arm, in the first direction, by the locking mechanism.

### CROSS-REFERENCE

This application claims priority from U.S. Provisional Patent Application No. 63/495,934, filed Apr. 13, 2023, entitled LOCKABLE RATCHET STRAP, the contents of which are incorporated by reference herein.

### FIELD

The present disclosure relates to a ratchet strap, and in particular, a ratchet strap wherein the arms are lockable via a locking mechanism.

### BACKGROUND

The function of a ratchet strap is to secure a load to a load supporter, such as cargo to a trailer. A ratchet strap further functions to secure an object while the ratchet strap is tied around the object, for example, a toolbox, such that, while the ratchet strap is tied around the toolbox, opening of a lid of the toolbox is opposed by the ratchet strap. Unfortunately, existing ratchet straps lack an anti-theft or anti-tampering mechanism. Accordingly, after the ratchet strap is tightened, for example, to secure the load to the load supporter or to secure the object, another user can loosen the ratchet strap, such that the securing of the load to the load supporter or the securing of the object is defeated.

### SUMMARY

In one aspect, there is provided a ratchet strap, comprising: a first arm, comprising a first locking counterpart of a locking mechanism; a second arm, comprising a second locking counterpart of the locking mechanism; a mandrel configured to connect to a strap; and a ratchet mechanism; wherein: the first arm, the second arm, the mandrel, and the ratchet mechanism are co-operatively configured such that: in response to rotation of the first arm, relative to the second arm, in a first direction, the mandrel is rotated in the first direction, relative to the second arm, via the ratchet mechanism, such that, while the strap is connected to the mandrel, the rotation of the mandrel in the first direction is with effect that the strap is wound about the mandrel; and in response to rotation of the first arm, relative to the second arm, in a second direction that is opposite the first direction, rotation of the mandrel, relative to the second arm, is opposed, via the ratchet mechanism; the first and second arms are configurable for disposition in a locking-ready relationship, wherein, while the first and second arms are disposed in the locking-ready relationship, the locking mechanism is configurable for disposition in: (i) a locking effective configuration, and (ii) a locking ineffective configuration; wherein: while: (i) the first and second arms are disposed in the locking-ready relationship, and (ii) the locking mechanism is disposed in the locking effective configuration, the first and second locking counterparts are co-operatively configured such that rotation of the first arm, relative to the second arm, is opposed by the first and second locking counterparts; and while: (i) the first and second arms are disposed in the locking-ready relationship, and (ii) the locking mechanism is disposed in the locking ineffective configuration, the first and second locking counterparts are co-operatively configured such that there is an absence of opposition of rotation of the first arm, relative to the second arm, in the first direction, by the first and second locking counterparts.

Other aspects will be apparent from the description and drawings provided herein.

### BRIEF DESCRIPTION OF DRAWINGS

In the figures, which illustrate example embodiments, FIG. 1 is a perspective view of an example embodiment of a ratchet strap, the ratchet strap disposed in a closed configuration;

FIG. 2 is a perspective view of the ratchet strap of FIG. 1, the ratchet strap disposed in an intermediate configuration;

FIG. 3 is a perspective view of the ratchet strap of FIG. 1, the ratchet strap disposed in an unwinding configuration;

FIG. 4 is a schematic of the ratchet strap of FIG. 1, the ratchet strap disposed in the closed configuration;

FIG. 5 is a schematic of the ratchet strap of FIG. 1, the ratchet strap disposed in the unwinding configuration;

FIG. 6 is a schematic of the ratchet strap of FIG. 1, the ratchet strap disposed in the intermediate configuration;

FIG. 7 is a side view of the ratchet strap of FIG. 1, the ratchet strap disposed in the intermediate configuration;

FIG. 8 is a side view of the ratchet strap of FIG. 1, the ratchet strap disposed in the closed configuration;

FIG. 9 is a top view of another example embodiment of a ratchet strap, the ratchet strap disposed in the closed configuration, and the locking mechanism disposed in the locking effective configuration; and

FIG. 10 is a side view of the ratchet strap of FIG. 9.

### DETAILED DESCRIPTION

Disclosed herein is a ratchet strap comprising a locking mechanism. The locking mechanism is configured to lock the first and second arms of the ratchet strap together. The first and second arms are lockable together via actuation of the locking mechanism. While the first and second arms are locked together, relative displacement the first and second arms is opposed (e.g. prevented) by the locking mechanism. Accordingly, while the first and second arms are locked together, ratcheting of the ratchet strap is opposed (e.g. prevented). In addition, while the first and second arms are locked together, disposition of the ratchet strap in an unwinding configuration, for unwinding the strap, is opposed (e.g. prevented). While the first and second arms are locked together, the locking of the first and second arms can be defeated via actuation of the locking mechanism. While there is an absence of locking of the first and second arms by the locking mechanism, relative displacement of the first and second arms is effectuatable, for example, to ratchet the ratchet strap, or to dispose the ratchet strap in the unwinding configuration for unwinding the strap.

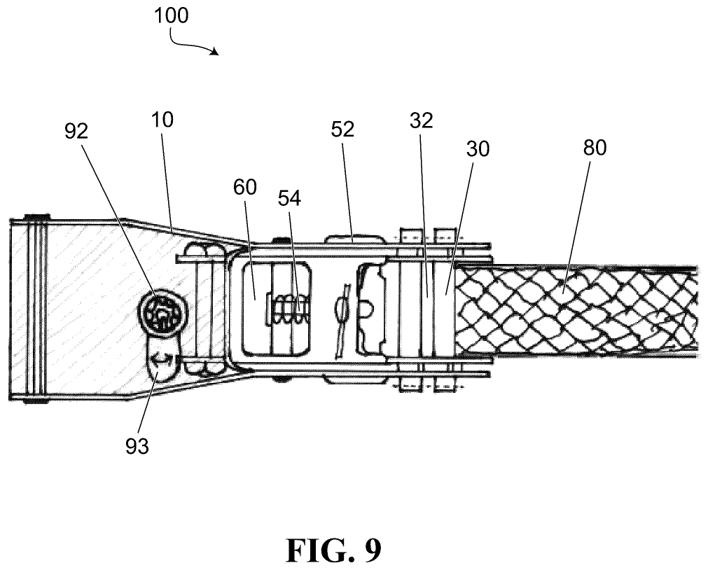

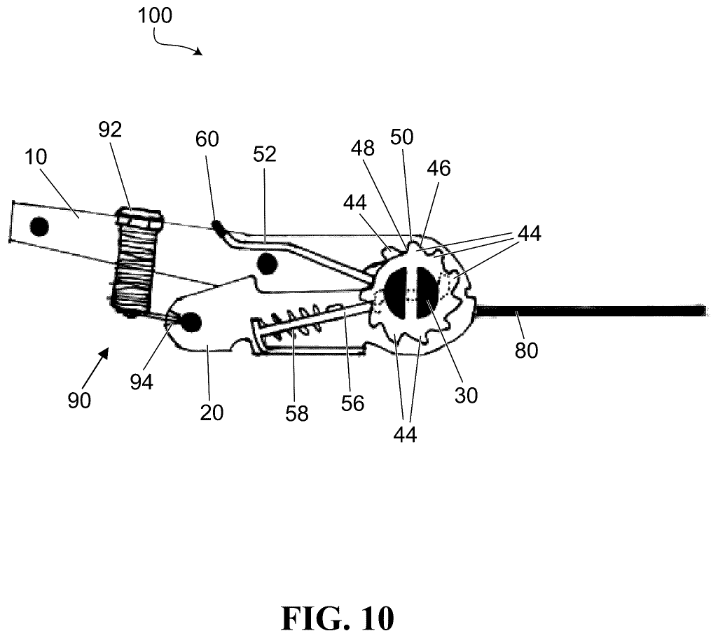

FIG. 1 to FIG. 3 and FIG. 7 to FIG. 8 depict an example embodiment of a ratchet strap 100. FIG. 9 and FIG. 10 depict another example embodiment of a ratchet strap 100. As depicted, the ratchet strap 100 includes a first arm 10 (e.g. an operating arm for interaction by a user to effectuate ratcheting of the ratchet strap 100), a second arm 20, a mandrel 30 configured to connect to a strap 80, and a ratchet mechanism 40. In some embodiments, for example, the ratchet strap 100 includes a strap 70 that is connected, at one end, to the second arm 20.

As depicted, in some embodiments, for example, each one of the first arm 10 and the second arm 20, independently, is connected to the mandrel 30, such that relative displacement, for example, relative rotation, between the first arm 10 and the second arm 20, is effectuatable.

In some embodiments, for example, relative rotation between the first arm 10 and the second arm 20 is effectuatable about a rotation axis that is parallel to a central longitudinal axis of the mandrel 30.

As depicted, in some embodiments, for example, the mandrel 30 defines a slot 32 for receiving the strap 80.

In some embodiments, for example, the ratchet mechanism 40 includes a ratchet gear or ratchet wheel 42. As depicted, the ratchet mechanism 40 includes two ratchet gears 42 disposed on opposite ends of the mandrel 30. The ratchet gear 42 includes a plurality of toothed members 44 or cam members. As depicted, for each one of the toothed members 44, independently, the toothed member 44 defines a first surface 46 and a second surface 48 that are connected at the tip 50 of the toothed member 44. As depicted, the first surface 46 has a relatively moderate slope, and the second surface 48 has a relatively steep slope. The slope of the first surface 46 and the slope of the second surface 48 are opposite. That is, if the slope of the first surface 46 is a positive slope, then the slope of the second surface 48 is a negative slope. Similarly, if the slope of the first surface 46 is a negative slope, then the slope of the second surface 48 is a positive slope. The ratchet gear 42 is connected to the mandrel 30 such that, in response to rotation of the ratchet gear 42 in a direction of rotation, the mandrel is also rotated in the same direction of rotation. In this respect, the ratchet gear 42 is connected to the mandrel 30 such that the ratchet gear 42 and the mandrel 30 rotate together.

In some embodiments, for example, the ratchet mechanism 40 further includes a first pawl 52, a first spring 54, a second pawl 56, and a second spring 58. As depicted, the first pawl 52 and the first spring 54 are connected to the first arm 10, and the second pawl 56 and second spring 58 are connected to the second arm 20.

The first pawl 52, the first spring 54, and the ratchet gear 42 are co-operatively configured such that the first pawl 52 is urged to be disposed in contact engagement (e.g. abutting engagement) with the ratchet gear 42 via the spring force applied to the first pawl 52 by the first spring 54.

The second pawl 56, the second spring 58, and the ratchet gear 42 are co-operatively configured such that the second pawl 56 is urged to be disposed in contact engagement (e.g. abutting engagement) with the ratchet gear 42 via the spring force applied to the second pawl 56 by the second spring 58.

In some embodiments, for example, the strap 70 is manufactured with Kevlar or a strong threaded material. In some embodiments, for example, the strap 70 includes metal threading. In some embodiments, for example, the strap 70 is a metal rope. In some embodiments, for example, the strap 70 is manufactured with weaved metal. In some embodiments, for example, the strap 70 is a cut-resistant strap. In some embodiments, for example, the strap 70 is configured to oppose cutting of the strap 70, for example, by a knife or scissors.

In some embodiments, for example, similar to the strap 70, the strap 80 is manufactured with Kevlar or a strong threaded material. In some embodiments, for example, the strap 80 includes metal threading. In some embodiments, for example, the strap 80 is a metal rope. In some embodiments, for example, the strap 80 is manufactured with weaved metal. In some embodiments, for example, the strap 80 is a cut-resistant strap. In some embodiments, for example, the strap 80 is configured to oppose cutting of the strap 80, for example, by a knife or scissors.

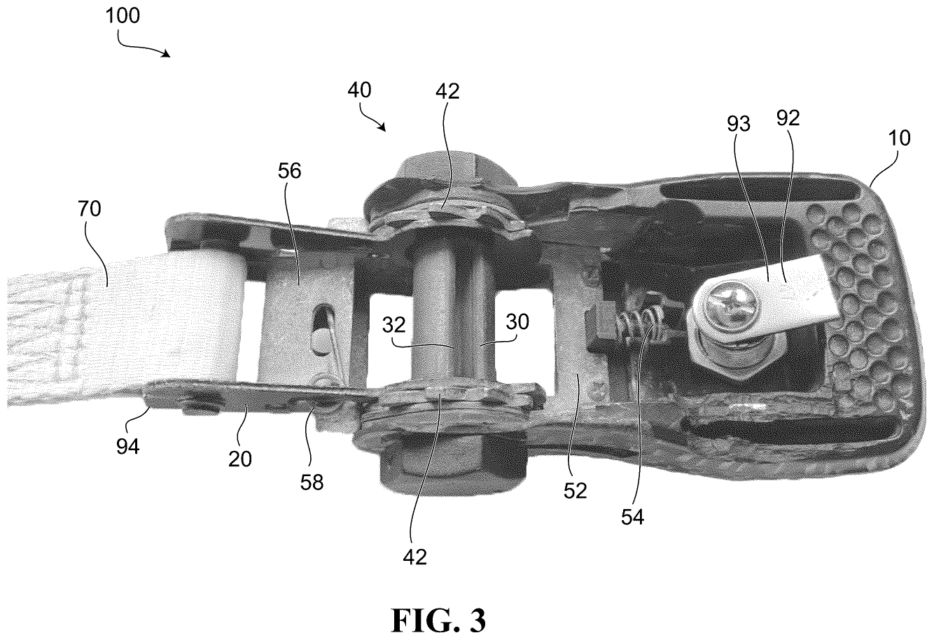

As depicted in FIGS. 1, 4, 8, 9, and 10, the ratchet strap 100 is configurable in a closed configuration. In some embodiments, for example, while the ratchet strap 100 is disposed in the closed configuration, the first arm 10 and the second arm 20 are disposed in opposing relationship. In some embodiments, for example, while the ratchet strap 100 is disposed in the closed configuration, at least a portion of the second arm 20 is nested within the first arm 10. In some embodiments, for example, while the ratchet strap 100 is disposed in the closed configuration, an angle α defined between: (i) a longitudinal axis 12 of the first arm 10, and (ii) a longitudinal axis 22 of the second arm 20, is an acute angle having a value of less than 15 degrees. In some embodiments, for example, while the ratchet strap 100 is disposed in the closed configuration, the acute angle α defined between: (i) the longitudinal axis 12 of the first arm 10, and (ii) the longitudinal axis 22 of the second arm 20, has a value of 0 degrees. In some embodiments, for example, while the ratchet strap 100 is disposed in the closed configuration, rotation of the first arm 10, relative to the second arm 20, in a direction towards the second arm 20 (e.g. counterclockwise direction), is opposed (e.g. prevented) by the second arm 20.

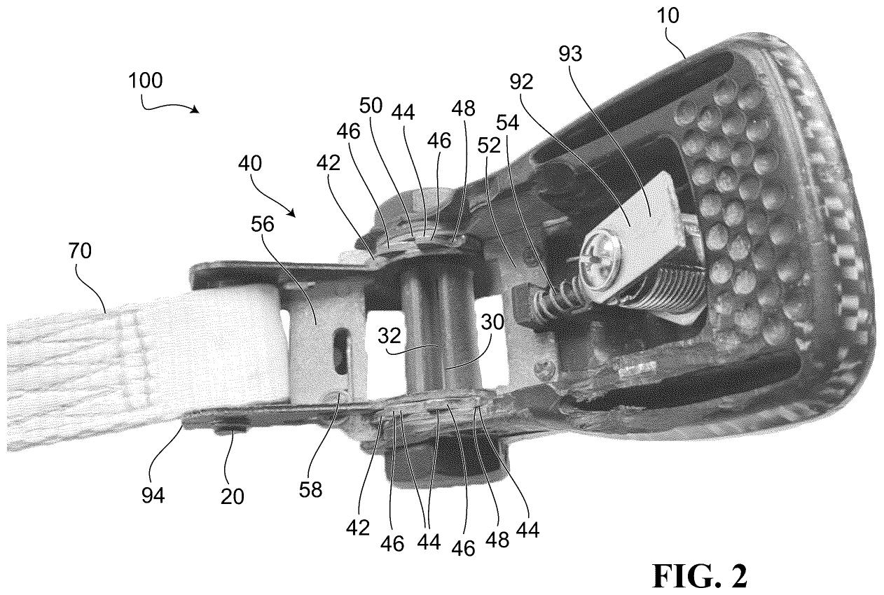

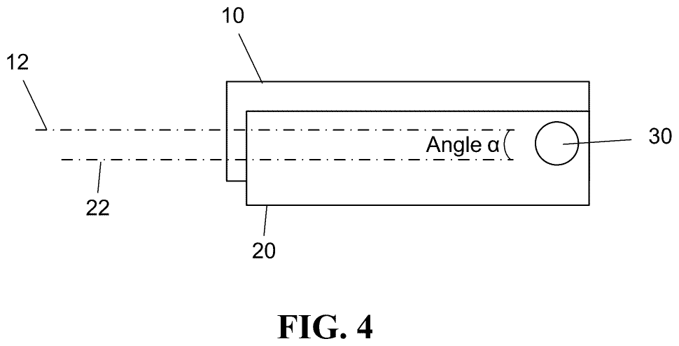

As depicted in FIG. 3 and FIG. 5, the ratchet strap 100 is configurable in an unwinding configuration. In some embodiments, for example, while the ratchet strap 100 is disposed in the unwinding configuration, the angle α defined between: (i) the longitudinal axis 12 of the first arm 10, and (ii) the longitudinal axis 22 of the second arm 20, is greater than 135 degrees. In some embodiments, for example, while the ratchet strap 100 is disposed in the unwinding configuration, the angle α defined between: (i) the longitudinal axis 12 of the first arm 10, and (ii) the longitudinal axis 22 of the second arm 20, is 160 degrees. In some embodiments, for example, while the ratchet strap 100 is disposed in the unwinding configuration, the angle α defined between: (i) the longitudinal axis 12 of the first arm 10, and (ii) the longitudinal axis 22 of the second arm 20, is 180 degrees.

In some embodiments, for example, while the ratchet strap 100 is disposed in the unwinding configuration, there is an absence of engagement between: (i) the ratchet gear 42, and (ii) each one of the first pawl 52 and the second pawl 56. In some embodiments, for example, while the ratchet strap 100 is disposed in the unwinding configuration, the first pawl 52 is disposed in abutting engagement with the second arm 20, and the second pawl 56 is disposed in abutting engagement with the first arm 10, such that there is an absence of engagement between: (i) the ratchet gear 42, and (ii) each one of the first pawl 52 and the second pawl 56. While the ratchet strap 100 is disposed in the unwinding configuration, the mandrel 30 is rotatable in a first direction (e.g. clockwise direction), and also rotatable in a second direction that is opposite the first direction (e.g. counterclockwise direction). In some embodiments, for example, while the ratchet strap 100 is disposed in the unwinding configuration, and the strap 80 is wound about the mandrel 30, the mandrel 30 is rotatable to unwind the strap 80 from the mandrel 30, such that the connection between the mandrel 30 and the strap 80 is defeatable.

In some embodiments, for example, the ratchet strap 100 includes a release tab 60 that is connected to the first pawl 52. A user can apply a force to the release tab 60 to overcome the spring force applied to the first pawl 52 by the first spring 54, with effect that there is an absence of engagement between the first pawl 52 and the ratchet gear 42. While there is an absence of engagement between the first pawl 52 and the ratchet gear 42, the first arm 10 is displaceable, for example, rotatable, relative to the second arm 20, such that the ratchet strap 100 becomes disposed in the unwinding configuration.

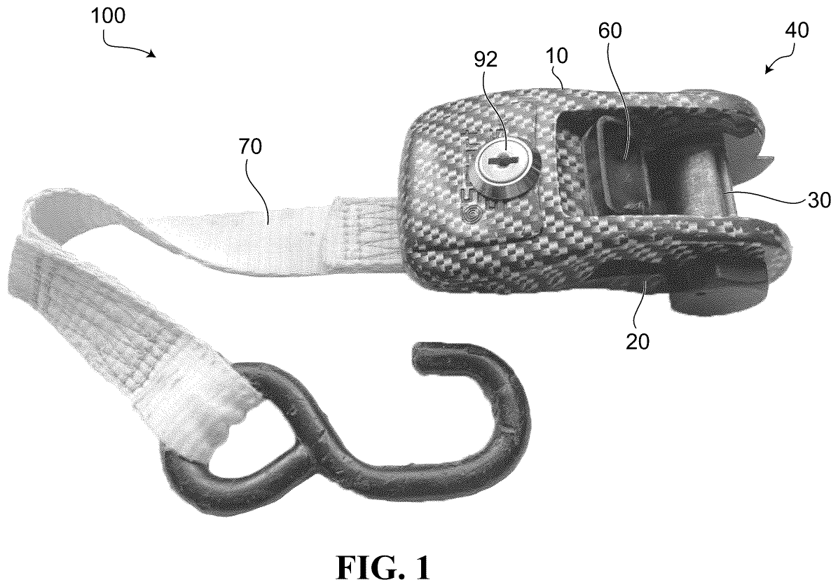

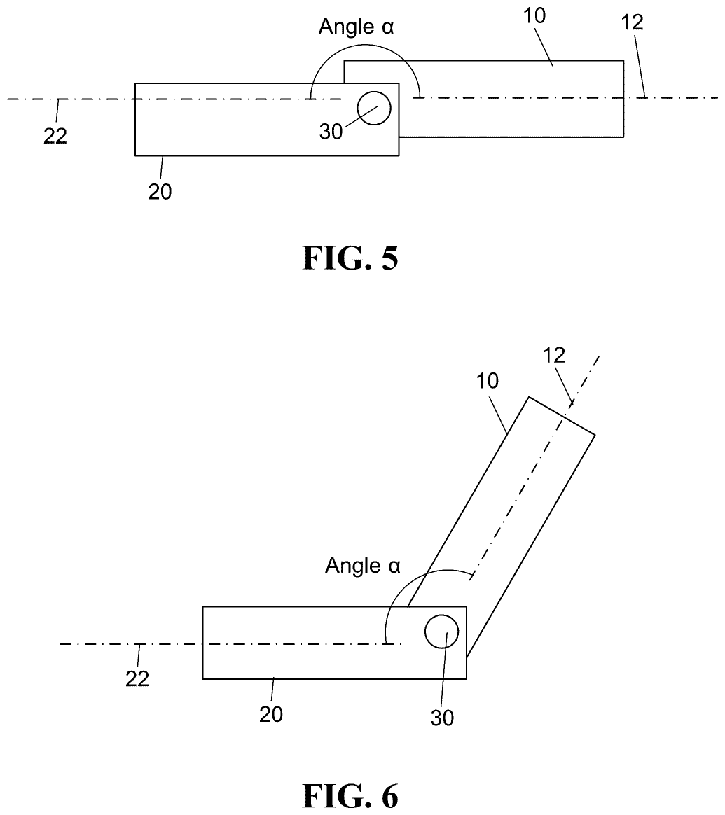

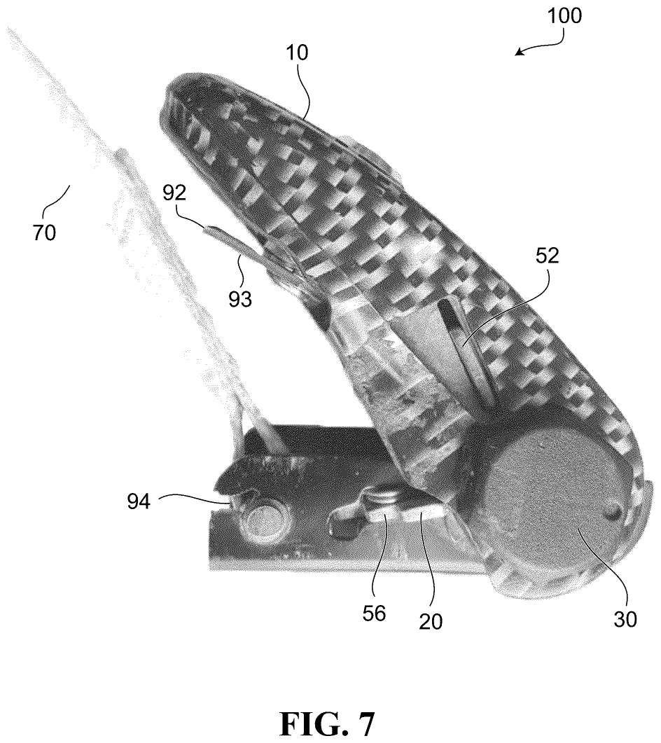

As depicted in FIG. 2, FIG. 6, and FIG. 7, the ratchet strap 100 is configurable in an intermediate configuration. In some embodiments, for example, while the ratchet strap 100 is disposed in the intermediate configuration, the angle α defined between: (i) the longitudinal axis 12 of the first arm 10, and (ii) the longitudinal axis 22 of the second arm 20, is between 15 degrees and 135 degrees. In some embodiments, for example, relative to its disposition in the closed configuration, while the ratchet strap 100 is disposed in the intermediate configuration, the first arm 10 is disposed further from the second arm 20. In some embodiments, for example, relative to its disposition in the unwinding configuration, while the ratchet strap 100 is disposed in the intermediate configuration, the first arm 10 is disposed closer the second arm 20.

In some embodiments, for example, while the ratchet strap 100 is disposed in the intermediate configuration, rotation of the first arm 10, relative to the second arm 20, in a first direction (e.g. in a direction away from the second arm 20, for example, a clockwise direction), is effectuatable. In some embodiments, for example, while the ratchet strap 100 is disposed in the intermediate configuration, rotation of the first arm 10, relative to the second arm 20, in a second direction that is opposite the first direction (e.g. in a direction towards the second arm 20, for example, a counterclockwise direction), is effectuatable.

To secure a load to a load supporter that is supporting the load via the ratchet strap 100, the strap 70 is connected to the load supporter, such that the second arm 20 is connected to the load supporter via the strap 70, and the strap 80 is connected, at one end, to the load supporter, and the second end of the strap 80 is run through the slot 32 and back over the mandrel 30, and the slack in the strap 80 is removed. At this point, the load is disposed between the ratchet strap 100 and the load supporter. The first pawl 52 is disposed in contact engagement with the ratchet gear 42, and disposed between the second surface 48 of a first toothed member 44 and the first surface 46 of an adjacent second toothed member 44. Similarly, the second pawl 56 is disposed in contact engagement with the ratchet gear 42, and disposed between the second surface 48 of a third toothed member 44 and the first surface 46 of an adjacent fourth toothed member 44.

In some embodiments, for example, the first arm 10, the second arm 20, the mandrel 30, and the ratchet mechanism 40 are co-operatively configured such that, in response to rotation of the first arm 10, relative to the second arm 20, in a first direction (e.g. clockwise direction), the mandrel 30 is rotated in the first direction, relative to the second arm 20, via the ratchet mechanism 40, such that, while the strap 80 is connected to the mandrel 30, the rotation of the mandrel in the first direction is with effect that the strap 80 is wound about the mandrel 30.

To wind the strap 80 about the mandrel 30 for securing the load to the load supporter, a user applies a force to the first arm 10 for rotating the first arm 10, relative to the second arm 20, in a first direction (e.g. clockwise direction). In response to rotation of the first arm 10, relative to the second arm 20, in the first direction, the first pawl 52 becomes disposed in abutting engagement with the second surface 48 of the first toothed member 44. In response to further rotation of the first arm 10, relative to the second arm 20, in the first pawl 52 applies a force to the second surface 48 of the first toothed member 44, with effect that the ratchet gear 42 is rotated, in the first direction. While the ratchet gear 42 is rotated in the first direction, the mandrel 30 is rotated in the first direction, due to the connection between the ratchet gear 42 and the mandrel 30. While the mandrel 30 is rotated in the first direction, the strap 80 is wound about the mandrel 30, thereby tightening the ratchet strap 100, for securing the load to the load supporter.

While the ratchet gear 42 is rotated, in the first direction, the first surface 46 of the fourth toothed member 44 applies a force to the second pawl 56. The force applied by the fourth toothed member 44 to the second pawl 56 overcomes the spring force applied to the second pawl 56 by the second spring 58, such that the second pawl 56 is displaced in a direction away from the ratchet gear 42. In some embodiments, for example, the displacement of the second pawl 56 in the direction away from the ratchet gear 42 is with effect that opposition of rotation of the ratchet gear 42, in the first direction, by the second pawl 56, is reduced, for example, is absent, such that further rotation of the ratchet gear 42 in the first direction is effectuatable. In response to further rotation of the ratchet gear 42 in the first direction, the tip 50 of the fourth toothed member 44 is displaced past the second pawl 56. At this point, the spring force applied to the second pawl 56 by the second spring 58 is with effect that the second pawl 56 is displaced towards the ratchet gear 42, such that the second pawl 56 becomes disposed in contact engagement (e.g. abutting engagement) with the ratchet gear 42.

The first arm 10 can continue to be rotated, relative to the second arm 20, in the first direction, as described above, for winding the strap 80 around the mandrel 30.

In some embodiments, for example, the first arm 10, the second arm 20, the mandrel 30, and the ratchet mechanism 40 are co-operatively configured such that, in response to rotation of the first arm 10, relative to the second arm 20, in a second direction that is opposite the first direction (e.g. counter clockwise direction), rotation of the mandrel 30, relative to the second arm 20, is opposed (e.g. prevented), via the ratchet mechanism 40.

The rotation of the first arm 10, relative to the second arm 20, in the first direction, is limited by a flange defined on the second arm 20. To continue to wind the strap 80 about the mandrel 30, the first arm 10 has to be first rotated, relative to the second arm 20, in a second direction that is opposite to the first direction (e.g. counterclockwise direction). While the first arm 10 is rotated, relative to the second arm 20, in the second direction, the first pawl 52 applies a force to the ratchet gear 42, with effect that the ratchet gear 42 is urged to rotate in the second direction. In response to urging of rotation of the ratchet gear 42 in the second direction, the second surface 48 of a toothed member 44 becomes disposed in abutting engagement with the second pawl 56, such that further rotation of the ratchet gear 42, in the second direction, is opposed (e.g. prevented). While the first arm 10 is rotated, relative to the second arm 20, in the second direction, and rotation of the ratchet gear 42, in the second direction, is opposed, the first surface 46 of the second toothed member 44 applies a force to the first pawl 42. The force applied by the second toothed member 44 to the first pawl 52 overcomes the spring force applied to the first pawl 52 by the first spring 54, such that the first pawl 52 is displaced in a direction away from the ratchet gear 42. In some embodiments, for example, the displacement of the first pawl 52 in the direction away from the ratchet gear 42 is with effect that opposition of rotation of the first arm 10, in the second direction, by the ratchet gear 42, is reduced, for example, is absent, such that further rotation of the first arm 10 in the second direction, relative to the second arm 20, is effectuatable. In some embodiments, for example, due to the opposition of rotation of the ratchet gear 42 in the second direction by the second pawl 56, the rotation of the first arm 10 in the second direction, relative to the second arm 20, is also relative to the ratchet gear 42 and the mandrel 30. In response to further rotation of the first arm 20 in the second direction, relative to the second arm 20, and also relative to the ratchet gear 42 and mandrel 30, the tip 50 of the second toothed member 44 is displaced past the first pawl 52. At this point, the spring force applied to the first pawl 52 by the first spring 54 is with effect that the first pawl 52 is displaced towards the ratchet gear 42, such that the first pawl 52 becomes disposed in contact engagement (e.g. abutting engagement) with the ratchet gear 42.

The first arm 10 can continue to be rotated, relative to the second arm 20, and also relative to the ratchet gear 42 and mandrel 30, in the second direction, as described above.

After the first arm 10 is rotated, relative to the second arm 20, and also relative to the ratchet gear 42 and mandrel 30, in the second direction, the first arm 10 can again be rotated, relative to the second arm 20, in the first direction, to further wind the strap 80 around the mandrel 30. The process outlined above can be repeated until the strap 80 and the strap 70 are tightened such that a securing force is applied to the load by the ratchet strap 100, with effect that the load is secured to the load supporter by the ratchet strap 100.

To defeat the securing of the load to the load supporter by the ratchet strap 100, the ratchet strap 100 can be disposed in the unwinding configuration. A user can apply a force to the release tab 60 to defeat the engagement between the first pawl 52 and the ratchet member 42, and then rotate the first arm 10, relative to the second arm 20, in the first direction, to effectuate the disposition of the ratchet strap 100 in the unwinding configuration. While the ratchet strap 100 is disposed in the unwinding configuration, the mandrel 30 is rotated in the second direction, relative to the first arm 10 and also the second arm 20, to unwind the strap 80 from the mandrel 30 defeat the connection between the strap 80 and the mandrel 30. At this point, the securing of the load to the load supporter is defeated. While the ratchet strap 100 is disposed in the unwinding configuration, the mandrel 30 is rotatable in the second direction, relative to the first arm 10 and also the second arm 20, due to the absence of engagement between: (i) the ratchet gear 42, and (ii) the first pawl 52 and the second pawl 56.

In some embodiments, for example, a plurality of loads are securable to a load supporter by the ratchet strap 100, and such securing is defeatable, in a manner substantially similar to the manner as described herein with respect to securing a load to a load supporter by the ratchet strap 100 and defeating of the securing of the load to the load supporter by the ratchet strap 100.

In some embodiments, for example, an object is secured by wrapping or tying the ratchet strap 100 around the object. The ratchet strap 100 is wrapped or tied around the object by tightening the ratchet strap 100 around the object, in a manner substantially similar to the manner as described herein with respect to tightening the strap 80 and the strap 70 about the load to secure the load to the load supporter. While the object is secured by the ratchet strap 100, displacement of a portion of the object, relative to the remaining portion of the object, is opposed, for example, prevented, by the ratchet strap 100. In some embodiments, for example, wherein the object is a toolbox, while the toolbox is secured by the ratchet strap 100, opening of a lid of the toolbox is opposed, for example, prevented, by the ratchet strap 100.

In some embodiments, for example, a plurality of objects are securable by a ratchet strap 100, and such securing is defeatable, in a manner substantially similar to the manner as described herein with respect to securing an object by the ratchet strap 100 and defeating of the securing of the object by the ratchet strap 100.

In some embodiments, for example, the ratchet strap 100 includes a locking mechanism 90, configured to lock the first arm 10 and the second arm 20 together, such that relative displacement, such as relative rotation, between the first arm 10 and the second arm 20 is opposed (e.g. prevented). In some embodiments, for example, the locking mechanism 90 includes a first locking counterpart 92 and a second locking counterpart 94. In some embodiments, for example, the first locking counterpart 92 includes a cam lock. In those embodiments wherein the first locking counterpart 92 includes a cam lock, the cam lock includes a cam 93 or locking plate 93. In some embodiments, for example, the second locking counterpart 94 includes a slot.

As depicted in FIG. 2, FIG. 9, and FIG. 10, in some embodiments, for example, the first arm 10 includes the first locking counterpart 92, and the second arm 20 includes the second locking counterpart 94.

In some embodiments, for example, the first arm 10 and the second arm 20 are configurable for disposition in a locking-ready relationship.

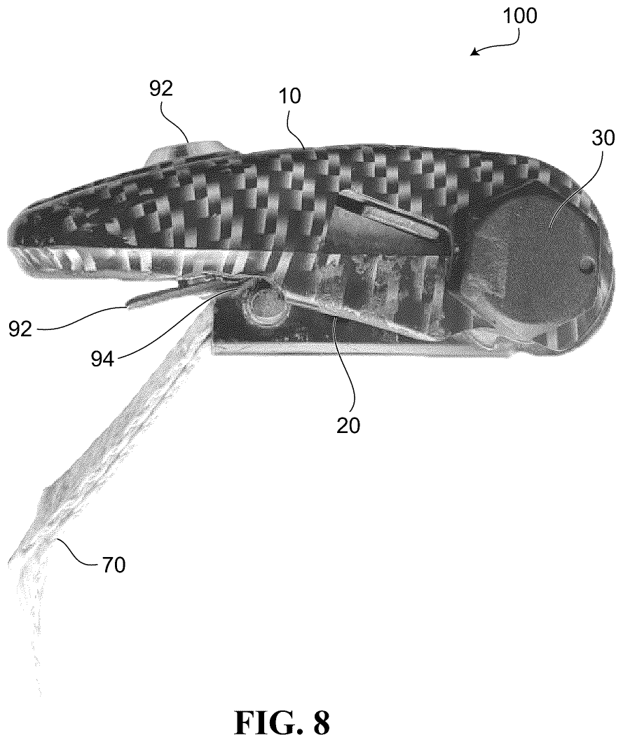

In some embodiments, for example, while the first arm 10 and the second arm 20 are disposed in the locking-ready relationship, the ratchet strap 100 is disposed in the closed configuration, as depicted in FIG. 8 and FIG. 10.

In some embodiments, for example, while the first arm 10 and the second arm 20 are disposed in the locking-ready relationship, the ratchet strap 100 is disposed in the intermediate configuration, as depicted in FIG. 7.

In some embodiments, for example, while the first arm 10 and the second arm 20 are disposed in the locking-ready relationship, the first locking counterpart 92 and the second locking counterpart 94 are relatively disposed such that an interaction is effectuatable between the first locking counterpart 92 and the second locking counterpart 94. In some embodiments, for example, while the first arm 10 and the second arm 20 are disposed in the locking-ready relationship, the first locking counterpart 92 and the second locking counterpart 94 are disposed in alignment.

In some embodiments, for example, while the first arm 10 and the second arm 20 are disposed in the locking-ready relationship, the locking mechanism 90 is configurable for disposition in: (i) a locking effective configuration, as depicted in FIG. 9 and FIG. 10, and (ii) a locking ineffective configuration, as depicted in FIGS. 1-3 and FIGS. 7-8.

In some embodiments, for example, while: (i) the first arm 10 and the second arm 20 are disposed in the locking-ready relationship, and (ii) the locking mechanism 90 is disposed in the locking effective configuration, the first locking counterpart 92 and the second locking counterpart 94 are co-operatively configured such that rotation of the first arm 10, relative to the second arm 20, is opposed (e.g. prevented), for example, by the locking mechanism 90, for example, by the first locking counterpart 92 and the second locking counterpart 94.

In some embodiments, for example, while: (i) the first arm 10 and the second arm 20 are disposed in the locking-ready relationship, and (ii) the locking mechanism 90 is disposed in the locking effective configuration, the opposition of rotation of the first arm 10, relative to the second arm 20, via the co-operative co-operation of the first locking counterpart 92 and the second locking counterpart 94, is such that: (i) rotation of the first arm 10, relative to the second arm 20, in the first direction (e.g. clockwise direction), is opposed (e.g. prevented); and (ii) rotation of the first arm 10, relative to the second arm 20, in the second direction that is opposite the first direction (e.g. counter clockwise direction), is opposed (e.g. prevented).

In some embodiments, for example, while: (i) the first arm 10 and the second arm 20 are disposed in the locking-ready relationship, and (ii) the locking mechanism 90 is disposed in the locking ineffective configuration, the first locking counterpart 92 and the second locking counterpart 94 are co-operatively configured such that there is an absence of opposition of rotation of the first arm 10, relative to the second arm 20, in the first direction, by the first locking counterpart 92 and the second locking counterpart 94.

In some embodiments, for example, while: (i) the first arm 10 and the second arm 20 are disposed in the locking-ready relationship, and (ii) the locking mechanism 90 is disposed in the locking effective configuration, the locking mechanism 90 is transitionable to the locking ineffective configuration via actuation of one of the first locking counterpart 92 and the second locking counterpart 94.

In some embodiments, for example, while: (i) the first arm 10 and the second arm 20 are disposed in the locking-ready relationship, and (ii) the locking mechanism 90 is disposed in the locking effective configuration, the transitioning of the locking mechanism 90 to the locking ineffective configuration is effectuated via actuation of the first locking counterpart 92.

In some embodiments, for example, the actuation of the one of the first locking counterpart 92 and the second locking counterpart 94, for example, the first locking counterpart 92, for transitioning of the locking mechanism 90 from the locking effective configuration to the locking ineffective configuration, is effectuated via a key. In some embodiments, for example, the actuation of the one of the first locking counterpart 92 and the second locking counterpart 94, for example, the first locking counterpart 92, for transitioning of the locking mechanism 90 from the locking effective configuration to the locking ineffective configuration, is effectuated via rotation of the first locking counterpart 92, relative to the first arm 10, in a first direction (e.g. clockwise direction).

In some embodiments, for example, while: (i) the first arm 10 and the second arm 20 are disposed in the locking-ready relationship, and (ii) the locking mechanism 90 is disposed in the locking ineffective configuration, the locking mechanism 90 is transitionable to the locking effective configuration via actuation of one of the first locking counterpart 92 and the second locking counterpart 94.

In some embodiments, for example, while: (i) the first arm 10 and the second arm 20 are disposed in the locking-ready relationship, and (ii) the locking mechanism 90 is disposed in the locking ineffective configuration, the transitioning of the locking mechanism 90 to the locking effective configuration is effectuated via actuation of the first locking counterpart 92.

In some embodiments, for example, the actuation of the one of the first locking counterpart 92 and the second locking counterpart 94, for example, the first locking counterpart 92, for transitioning of the locking mechanism 90 from the locking ineffective configuration to the locking effective configuration, is effectuated via a key. In some embodiments, for example, the actuation of the one of the first locking counterpart 92 and the second locking counterpart 94, for example, the first locking counterpart 92, for transitioning of the locking mechanism 90 from the locking ineffective configuration to the locking effective configuration, is effectuated via rotation of the first locking counterpart 92, relative to the first arm 10, in a second direction that is opposite the first direction (e.g. counter clockwise direction).

In some embodiments, for example, while: (i) the first arm 10 and the second arm 20 are disposed in the locking-ready relationship (e.g. while the ratchet strap 100 is disposed in the closed configuration), and (ii) the locking mechanism 90 is disposed in the locking ineffective configuration, rotation of the first arm 10, relative to the second arm 20, in the second direction (e.g. counter clockwise direction), is opposed (e.g. prevented) by the second arm 20.

In some embodiments, for example, while the first arm 10 and the second arm 20 are disposed in the locking-ready relationship (e.g. while the ratchet strap 100 is disposed in the closed configuration), rotation of the first arm 10, relative to the second arm 20, in the second direction (e.g. counterclockwise direction), is opposed (e.g. prevented) by the second arm 20.

In some embodiments, for example, while: (i) the first arm 10 and the second arm 20 are disposed in the locking-ready relationship (e.g. while the ratchet strap 100 is disposed in the intermediate configuration), and (ii) the locking mechanism 90 is disposed in the locking ineffective configuration, the first arm 10 is rotatable, relative to the second arm 20 (e.g. counterclockwise direction), in the second direction.

In some embodiments, for example, while the first arm 10 and the second arm 20 are disposed in the locking-ready relationship (e.g. while the ratchet strap 100 is disposed in the intermediate configuration), the first arm 10 is rotatable, relative to the second arm 20 (e.g. counterclockwise direction), in the second direction.

In some embodiments, for example, while the ratchet strap 100 is disposed in the locking-ready relationship, the first arm 10 and the second arm 20 are co-operatively configured to conceal a portion of the first locking counterpart 92 that is disposed internally of the ratchet strap 100. In those embodiments wherein the first locking counterpart 92 includes a cam lock, the portion of the first locking counterpart 92 that is disposed internally of the ratchet strap 100 includes the cam 93. In some embodiments, for example, while the ratchet strap 100 is disposed in the locking-ready relationship, the first arm 10 and the second arm 20 are co-operatively configured to conceal a portion of the first locking counterpart 92 that is disposed between the first arm 10 and the second arm 20. In those embodiments wherein the first locking counterpart 92 includes a cam lock, the portion of the first locking counterpart 92 that is concealed by the first arm 10 and the second arm 20 includes the cam 93.

In some embodiments, for example, while the ratchet strap 100 is disposed in the locking-ready relationship, and the locking mechanism 90 is disposed in the locking effective configuration, the first arm 10 and the second arm 20 are co-operatively configured to oppose (e.g. prevent) an interaction with at least one of the first locking counterpart 92 or the second locking counterpart 94, wherein the interaction is effective for defeating the locking effective configuration. In some embodiments, for example, while the ratchet strap 100 is disposed in the locking-ready relationship, and the locking mechanism 90 is disposed in the locking effective configuration, the first arm 10 and the second arm 20 are co-operatively configured to oppose (e.g. prevent) an interaction with at least one of the first locking counterpart 92 or the second locking counterpart 94, wherein the interaction is effective for transitioning the locking mechanism 90 to the locking ineffective configuration. In some embodiments, for example, the interaction includes application of a force, for example, from an external source such as a tool, to the at least one of the first locking counterpart 92 or the second locking counterpart 94. In some embodiments, for example, while the ratchet strap 100 is disposed in the locking-ready relationship, and the locking mechanism 90 is disposed in the locking effective configuration, the first arm 10 and the second arm 20 are co-operatively configured to oppose (e.g. prevent) the interaction with the first locking counterpart 92, for example, with at least a portion of the first locking counterpart 92 that is concealed by the first arm 10 and the second arm 20. In some embodiments, for example, while the ratchet strap 100 is disposed in the locking-ready relationship, and the locking mechanism 90 is disposed in the locking effective configuration, the first arm 10 and the second arm 20 are co-operatively configured to oppose (e.g. prevent) the interaction with the first locking counterpart 92, for example, with at least a portion of the first locking counterpart 92 that is disposed internally of the ratchet strap 100. In some embodiments, for example, wherein the first locking counterpart 92 includes the cam lock, while the ratchet strap 100 is disposed in the locking-ready relationship, and the locking mechanism 90 is disposed in the locking effective configuration, the first arm 10 and the second arm 20 are co-operatively configured to oppose (e.g. prevent) the interaction with the cam 93. In some embodiments, for example, the interaction includes application of a force, for example, from an external source such as a tool, to the first locking counterpart 92, for example, to the cam 93. In some embodiments, for example, while the ratchet strap 100 is disposed in the locking-ready relationship, and the locking mechanism 90 is disposed in the locking effective configuration, the first arm 10 and the second arm 20 are co-operatively configured to oppose (e.g. prevent) tampering of the concealed portion of the first locking counterpart 92, for example, via an external source such as a tool.

In some embodiments, for example, while the ratchet strap 100 is disposed in the locking-ready relationship, and the locking mechanism 90 is disposed in the locking ineffective configuration, the first arm 10 and the second arm 20 are co-operatively configured to oppose (e.g. prevent) an interaction with at least one of the first locking counterpart 92 or the second locking counterpart 94, in a manner substantially similar to the manner as described herein with respect to the opposing (e.g. preventing) of an interaction with at least one of the first locking counterpart 92 or the second locking counterpart 94 via the co-operative configuration of the first arm 10 and the second arm 20 while the ratchet strap 100 is disposed in the locking-ready relationship and the locking mechanism 90 is disposed in the locking effective configuration.

In some embodiments, for example, after the load is secured to the load supporter via the ratchet strap 100, the first arm 10 and second arm 20 are disposed in the locking-ready relationship (e.g. the ratchet 100 is disposed in the closed configuration). At this point, the locking mechanism 90 is disposed in the locking ineffective configuration. While the first arm 10 and second arm 20 are disposed in the locking-ready relationship, the user actuates the first locking counterpart 92, for example, via a key, such that the locking mechanism 90 becomes disposed in the locking effective configuration. At this point, the first locking counterpart 92 and the second locking counterpart 94 are co-operatively configured such that rotation of the first arm 10, relative to the second arm 20, is opposed (e.g. prevented), such that: (i) further tightening of the strap 80, for example, to damage the load, is opposed (e.g. prevented), and (ii) disposition of the ratchet strap 100 in the unwinding configuration, for example, to defeat the securing of the load to the load supporter, is opposed (e.g. prevented).

While: (i) the the first arm 10 and second arm 20 are disposed in the locking-ready relationship, and (ii) the locking mechanism 90 is disposed in the locking effective configuration, to rotate the first arm 10, relative to the second arm 20, in the first direction, for example, to dispose the ratchet strap 100 in the unwinding configuration to loosen the strap 80, the user has to first actuate the first locking counterpart 92, for example, via the key, such that the locking mechanism 90 becomes disposed in the locking ineffective configuration.

In some embodiments, for example, after an object is secured by wrapping or tying the ratchet strap 100 around the object, the first arm 10 and second arm 20 are disposed in the locking-ready relationship, and the locking mechanism 90 is operated in a manner substantially similar to the manner as described herein to dispose the locking mechanism 90 in the locking effective configuration, for example, to oppose (e.g. prevent) further tightening of the strap 80 and oppose (e.g. prevent) disposition of the ratchet strap 100 in the unwinding configuration, and in the locking ineffective configuration, for example, to dispose the ratchet strap 100 in the unwinding configuration to loosen the strap 80.

In this respect, in some embodiments, for example, the ratchet strap 100 provides anti-theft and anti-tampering functionality to protect the load that is secured to the load supporter or to protect the object that is secured by the ratchet strap 100.

The preceding discussion provides many example embodiments. Although each embodiment represents a single combination of inventive elements, other examples may include all suitable combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations could be made herein.

Moreover, the scope of the present application is not intended to be limited to the particular embodiments of the process, machine, manufacture, and composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be examples only. The invention is defined by the appended claims.

What is claimed is:

1. A ratchet strap, comprising:
a first arm, comprising a first locking counterpart of a locking mechanism;
a second arm, comprising a second locking counterpart of the locking mechanism;
a mandrel configured to connect to a strap; and
a ratchet mechanism;
wherein:
the first arm, the second arm, the mandrel, and the ratchet mechanism are co-operatively configured such that:
in response to rotation of the first arm, relative to the second arm, in a first direction, the mandrel is rotated in the first direction, relative to the second arm, via the ratchet mechanism, such that, while the strap is connected to the mandrel, the rotation of the mandrel in the first direction is with effect that the strap is wound about the mandrel; and
in response to rotation of the first arm, relative to the second arm, in a second direction that is opposite the first direction, rotation of the mandrel, relative to the second arm, is opposed, via the ratchet mechanism;
the first and second arms are configurable for disposition in a locking-ready relationship, wherein, while the first and second arms are disposed in the locking-ready relationship, the locking mechanism is configurable for disposition in: (i) a locking effective configuration, and (ii) a locking ineffective configuration;
wherein:
while: (i) the first and second arms are disposed in the locking-ready relationship, and (ii) the locking mechanism is disposed in the locking effective configuration, the first and second locking counterparts are co-operatively configured such that rotation of the first arm, relative to the second arm, is opposed by the first and second locking counterparts; and
while: (i) the first and second arms are disposed in the locking-ready relationship, and (ii) the locking mechanism is disposed in the locking ineffective configuration, the first and second locking counterparts are co-operatively configured such that there is an absence of opposition of rotation of the first arm, relative to the second arm, in the first direction, by the first and second locking counterparts.

2. The ratchet strap of claim 1, wherein:
while: (i) the first and second arms are disposed in the locking-ready relationship, and (ii) the locking mechanism is disposed in the locking effective configuration, the locking mechanism is transitionable to the locking ineffective configuration via actuation of one of the first locking counterpart and the second locking counterpart.

3. The ratchet strap of claim 2, wherein:
while: (i) the first and second arms are disposed in the locking-ready relationship, and (ii) the locking mechanism is disposed in the locking effective configuration, the transitioning of the locking mechanism to the locking ineffective configuration is effectuated via actuation of the first locking counterpart.

4. The ratchet strap of claim 1, wherein:
while: (i) the first and second arms are disposed in the locking-ready relationship, and (ii) the locking mechanism is disposed in the locking ineffective configuration, the locking mechanism is transitionable to the locking effective configuration via actuation of one of the first locking counterpart and the second locking counterpart.

5. The ratchet strap of claim 4, wherein:
while: (i) the first and second arms are disposed in the locking-ready relationship, and (ii) the locking mechanism is disposed in the locking ineffective configuration, the transitioning of the locking mechanism to the locking effective configuration is effectuated via actuation of the first locking counterpart.

6. The ratchet strap of claim 1, wherein:
while: (i) the first and second arms are disposed in the locking-ready relationship, and (ii) the locking mechanism is disposed in the locking ineffective configuration, rotation of the first arm, relative to the second arm, in the second direction, is opposed by the second arm.

7. The ratchet strap of claim 1, wherein:
while the first and second arms are disposed in the locking-ready relationship, rotation of the first arm, relative to the second arm, in the second direction, is opposed by the second arm.

8. The ratchet strap of claim 1, wherein:
while: (i) the first and second arms are disposed in the locking-ready relationship, and (ii) the locking mechanism is disposed in the locking ineffective configuration, the first arm is rotatable, relative to the second arm, in the second direction.

9. The ratchet strap of claim 1, wherein:
while the first and second arms are disposed in the locking-ready relationship, the first arm is rotatable, relative to the second arm, in the second direction.

10. The ratchet strap of claim 1, wherein:
while the first and second arms are disposed in the locking-ready relationship, the first and second arms are disposed in opposing relationship.

11. The ratchet strap of claim 1, wherein:
while the first and second arms are disposed in the locking-ready relationship, at least a portion of the second arm is nested within the first arm.

12. The ratchet strap of claim 1, wherein:
while the first and second arms are disposed in the locking-ready relationship, an angle defined between: (i) a longitudinal axis of the first arm, and (ii) a longitudinal axis of the second arm, is an acute angle having a value of less than 15 degrees.

13. The ratchet strap of claim 12, wherein;
while the first and second arms are disposed in the locking-ready relationship, the angle defined between: (i) the longitudinal axis of the first arm, and (ii) the longitudinal axis of the second arm, is 0 degrees.

14. The ratchet strap of claim 1, wherein:
while: (i) the first and second arms are disposed in the locking-ready relationship, and (ii) the locking mechanism is disposed in the locking effective configuration, the opposition of rotation of the first arm, relative to the second arm, via the co-operative co-operation of the first and second locking counterparts, is such that:
rotation of the first arm, relative to the second arm, in the first direction, is opposed by the first and second locking counterparts; and
rotation of the first arm, relative to the second arm, in the second direction, is opposed by the first and second locking counterparts.

15. The ratchet strap of claim 1, wherein:
the first locking counterpart includes a cam lock that includes a cam;
the second locking counterpart includes a slot configured for receiving the cam:
wherein, while the locking mechanism is disposed in the locking effective configuration, the cam is disposed in the slot; and
while the locking mechanism is disposed in the locking ineffective configuration, there is an absence of disposition of the cam in the slot.

16. The ratchet strap of claim 1, wherein:
while: (i) the first and second arms are disposed in the locking-ready relationship, and (ii) the locking mechanism is disposed in the locking effective configuration, the first arm and the second arm are co-operatively configured to oppose application of a force from an external source to at least one of the first locking counterpart or the second locking counterpart, wherein the application of the force is effective for defeating the locking effective configuration.

17. The ratchet strap of claim 1, wherein:
while: (i) the first and second arms are disposed in the locking-ready relationship, and (ii) the locking mechanism is disposed in the locking effective configuration, the first arm and the second arm are co-operatively configured to oppose application of a force from an external source to at least one of the first locking counterpart or the second locking counterpart, wherein the application of the force is effective for transitioning the locking mechanism from the locking effective configuration to the locking ineffective configuration.

18. The ratchet strap of claim 1, wherein:
the first locking counterpart includes a cam lock that includes a cam;
the second locking counterpart includes a slot configured for receiving the cam;
wherein:
while the locking mechanism is disposed in the locking effective configuration, the cam is disposed in the slot; and
while the locking mechanism is disposed in the locking ineffective configuration, there is an absence of disposition of the cam in the slot; and
while: (i) the first and second arms are disposed in the locking-ready relationship, and (ii) the locking mechanism is disposed in the locking effective configuration, the first arm and the second arm are co-operatively configured to oppose application of a force from an external source to the cam, wherein the application of the force is effective for defeating the locking effective configuration.

19. The ratchet strap of claim 18, wherein:
while: (i) the first and second arms are disposed in the locking-ready relationship, and (ii) the locking mechanism is disposed in the locking effective configuration, the first arm and the second arm are co-operatively configured to conceal the cam, such that the application of the force from the external source is opposed.
